(19) United States
(12) Patent Application Publication
(10) Pub. No.: US 2025/0173709 A1
(43) Pub. Date: May 29, 2025

(54) COMPUTER-IMPLEMENTED METHODS AND SYSTEMS FOR AUTHENTIC USER-MERCHANT ASSOCIATION AND SERVICES

(71) Applicant: Mastercard International Incorporated, Purchase, NY (US)

(72) Inventors: Kaushal Naveen Shetty, O'Fallon, MO (US); Sachin Kumar Singh, Pune (IN)

(73) Assignee: Mastercard International Incorporated, Purchase, NY (US)

(21) Appl. No.: 19/042,198

(22) Filed: Jan. 31, 2025

Related U.S. Application Data
(63) Continuation of application No. 17/569,294, filed on Jan. 5, 2022, now Pat. No. 12,236,422.

(51) Int. Cl. G06Q 20/38; G06Q 20/40; G06Q 30/018; H04L 9/40

(52) U.S. Cl. CPC G06Q 20/38215; G06Q 20/4016; G06Q 30/0185; H04L 63/0823; H04L 63/10

(57) ABSTRACT

A system for identifying genuine user-merchant association. The system includes one or more processors and/or transceivers individually or collectively programmed to check the validity or expiration of a certificate from a device from which a request originates to create a certificate score, analyze previous communication from the device from which the request originates across a plurality of entities and regions to create a previous communication score, and conduct a messaging protocol check to create a protocol score. The one or more processors and/or transceivers are also programmed to output a weighted final score comprising a determination of whether to accept or deny the request based at least in part on one or more of the certificate scores, the previous communication score, or the protocol score. The one or more processors and/or transceivers are also programmed to save the weighted final score.

### RELATED APPLICATIONS

This application is a continuation application of co-pending and identically-titled U.S. patent application Ser. No. 17/569,294, filed Jan. 5, 2022, which is hereby incorporated herein by reference in its entirety.

### FIELD OF THE INVENTION

The present disclosure generally relates to computer-implemented methods, systems comprising computer-readable media, and electronic devices for authentic user-merchant association and services.

### BACKGROUND

Existing user-merchant association and services may be used for merchants to sell subscription services to users. Merchants often offer trial memberships to users, such that a user may test the trial membership prior to purchasing a full membership.

However, existing user-merchant association may be compromised by fraudulent users. For example, a fraudulent user may generate false and/or temporary methods of identification to fraudulently utilize a trial period of a subscription service multiple times and thereby avoid purchasing a full subscription service. Systems and methods for combatting fraudulent behavior are needed.

This background discussion is intended to provide information related to the present invention which is not necessarily prior art.

### BRIEF SUMMARY

The following brief summary is provided to indicate the nature of the subject matter disclosed herein. While certain aspects of the present invention are described below, the summary is not intended to limit the scope of the present invention.

A first aspect of the invention concerns a system for identifying genuine user-merchant association. The system includes one or more processors and/or transceivers individually or collectively programmed to check the validity or expiration of a certificate from a device from which a request originates to create a certificate score, analyze previous communication from the device from which the request originates across a plurality of entities and regions to create a previous communication score, and conduct a messaging protocol check to create a protocol score. The one or more processors and/or transceivers are also programmed to output a weighted final score comprising a determination of whether to accept or deny the request based at least in part on one or more of the certificate score, the previous communication score, or the protocol score. The one or more processors and/or transceivers are also programmed to save the weighted final score.

A second aspect of the invention concerns a computer-implemented method for identifying genuine user-merchant association. The method includes checking the validity or expiration of a certificate from a device from which a request originates to create a certificate score. The method also includes analyzing previous communication from the device from which the request originates across a plurality of entities and regions to create a previous communication score. The method also includes conducting a messaging protocol check to create a protocol score. The method also includes outputting a weighted final score comprising a determination of whether to accept or deny the request based at least in part on one or more of the certificate score, the previous communication score, or the protocol score. The method also includes saving the weighted final score.

A third aspect of the invention concerns a computer-implemented method for identifying genuine user-merchant association. The method includes verifying that a telephone address by which a subscription request was submitted belongs to a telephone address carrier, to create a carrier association score. The method also includes analyzing source address information of at least one packet associated with the telephone address to create a source score. The method also includes sending to the telephone address a ping, wherein the ping enables the retrieval of identifying features of the telephone address, to create an identification score. The method also includes outputting a weighted final score comprising a determination of whether to accept or deny the request based at least in part on one or more of the carrier association score, the source score, or the identification score. The method also includes saving the weighted final score.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates, in schematic and block diagram form, an exemplary system including a fraud manager computing device for authentic user-merchant association and services according to the embodiments of the invention;

FIG. 2 illustrates various components of an exemplary fraud manager computing device shown in block schematic form that may be used with the system of FIG. 1;

FIG. 3 is a flowchart illustrating at least a portion of the steps for running an email check service program in accordance with embodiments of the present invention;

FIG. 4 is a flowchart illustrating at least a portion of the steps for running a mobile check service program in accordance with embodiments of the present invention; and

FIG. 5 is a flowchart illustrating at least a portion of the steps used for generating a score used in connection with determining whether to accept or deny a subscription service request in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

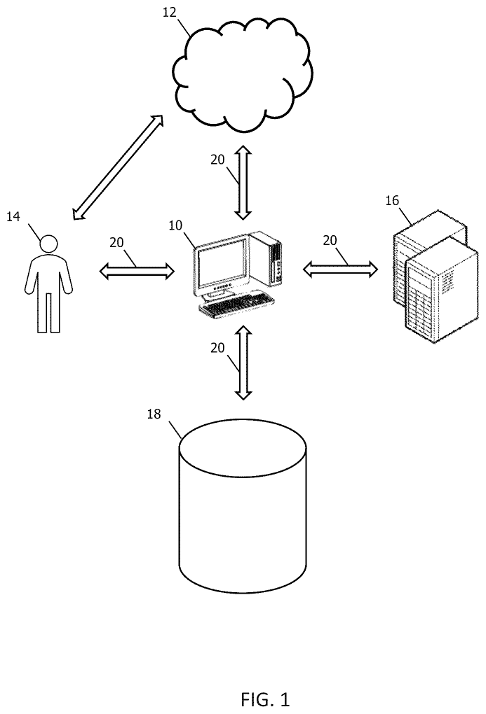

FIG. 1 depicts an exemplary system for authentic user-merchant association and services according to embodiments of the invention. The system may include a plurality of fraud manager computing devices 10, disposable authentication clouds 12, users 14, services servers 16, databases 18, and communication links 20. The fraud manager(s) 10 may comprise computing devices configured to process input and output from the disposable authentication cloud 12, user 14, services server 16, and database 18. The user 14 may be an individual attempting to exhaust a trial membership to a subscription service granted by the services server 16. The user may interface with the disposable authentication cloud 12 to obtain a randomly generated phone number, email address, or other means of online identification. The services server 16 may include a plurality of servers configured to grant or deny access to a trial membership for services (e.g., online services). Such services may relate to ecommerce, ride sharing services, online gaming memberships, or the like. The database 18 may be accessed by the fraud manager 10 and may be configured to store and provide or expose data related to a plurality of attempts to access a subscription service in which previous user(s) were denied access (e.g., by the fraud manager 10).

The fraud managers 10 and the services servers 16 may be located within network boundaries of a large organization, such as a service provider. The disposable authentication cloud 12 may be external to the organization, for example where fraudulent phone numbers or email addresses are generated in connection with accessing subscription services.

The fraud managers 10 may generally include tablet computers, laptop computers, desktop computers, workstation computers, smart phones, smart watches, and the like. In addition, fraud managers 10 may include servers.

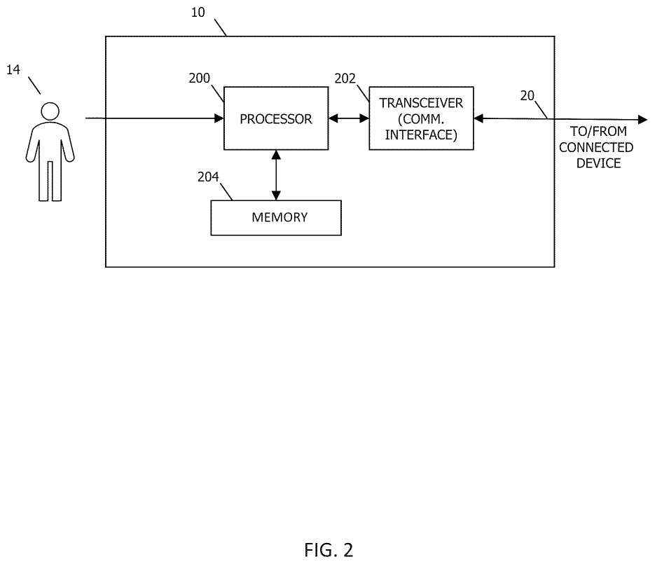

Turning to FIG. 2, each fraud manager 10 may respectively include a processing element 200 and a memory element 204. Each fraud manager 10 may also respectively include circuitry capable of wired and/or wireless communication with the disposable authentication cloud 12, users 14, services servers 16, databases 18, and/or an external network via, for example, a transceiver element 202 and communication link 20. Further, the fraud managers 10 may respectively include a software program configured with instructions for performing and/or enabling performance of at least some of the steps set forth herein. In an embodiment, the software comprises programs stored on computer-readable media of memory element 204.

The services server 16 may include a plurality of proxy servers, web servers, communications servers, routers, load balancers, and/or firewall servers, as are commonly known.

The transceiver element 202 generally allows communication between the fraud managers 10 on the one hand and the services servers 16, databases 18, users 14 and the disposable authentication cloud 12 on the other hand. The transceiver element 202 may include signal or data transmitting and receiving circuits, such as antennas, amplifiers, filters, mixers, oscillators, digital signal processors (DSPs), and the like. The transceiver element 202 may establish communication via the communication links 20 wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver element 202 may utilize communication standards such as ANT, ANT+, Bluetooth™ low energy (BLE), the industrial, scientific, and medical (ISM) band at 2.4 gigahertz (GHz), or the like. Alternatively, or in addition, the transceiver element 202 may establish communication through the communication links 20. The communication links 20 may include connectors or couplers that receive metal conductor wires or cables, like Cat 6 or coax cable, which are compatible with networking technologies such as ethernet. In certain embodiments, the communication links 20 may also include optical fiber cables. The transceiver element 202 may respectively be in communication with the processing element 200 and/or the memory element 204, via the communication links 20.

The communication links 20 may include the Internet, cellular communication networks, local area networks, metro area networks, wide area networks, cloud networks, plain old telephone service (POTS) networks, and the like, or combinations thereof. The links 20 may be wired, wireless, or combinations thereof and may include components such as modems, gateways, switches, routers, hubs, access points, repeaters, towers, and the like. The links 20 may enable communication between one or more of the fraud managers 10, disposable authentication cloud 12, users 14, services servers 16, and databases 18. The communication links 20 may include wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The memory element 204 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 204 may be embedded in, or packaged in the same package as, the processing element 200. The memory element 204 may include, or may constitute, a “computer-readable medium.” The memory element 204 may store the instructions, code, code segments, software, firmware, programs, applications, apps, services, daemons, or the like that are executed by the processing element 200. In an embodiment, the memory element 204 may respectively store the software applications/programs. The memory element 204 may also store settings, data, documents, sound files, photographs, movies, images, databases, and the like.

The processing element 200 may include electronic hardware components such as processors. The processing element 200 may include a digital processing unit. The processing element 200 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 200 may generally execute, process, or run instructions, code, code segments, software, firmware, programs, applications, apps, processes, services, daemons, or the like. For instance, the processing element 200 may respectively execute the software applications/programs. The processing element 200 may also include hardware components such as finite-state machines, sequential and combinational logic, and other electronic circuits that can perform the functions necessary for the operation of the current invention. The processing element 200 may be in communication with the other electronic components through serial or parallel links that include universal busses, address busses, data busses, control lines, and the like.

Through hardware, software, firmware, or various combinations thereof, the processing element 200 may—alone or in combination with other processing elements-be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Method for Authentic User-Merchant Association and Services

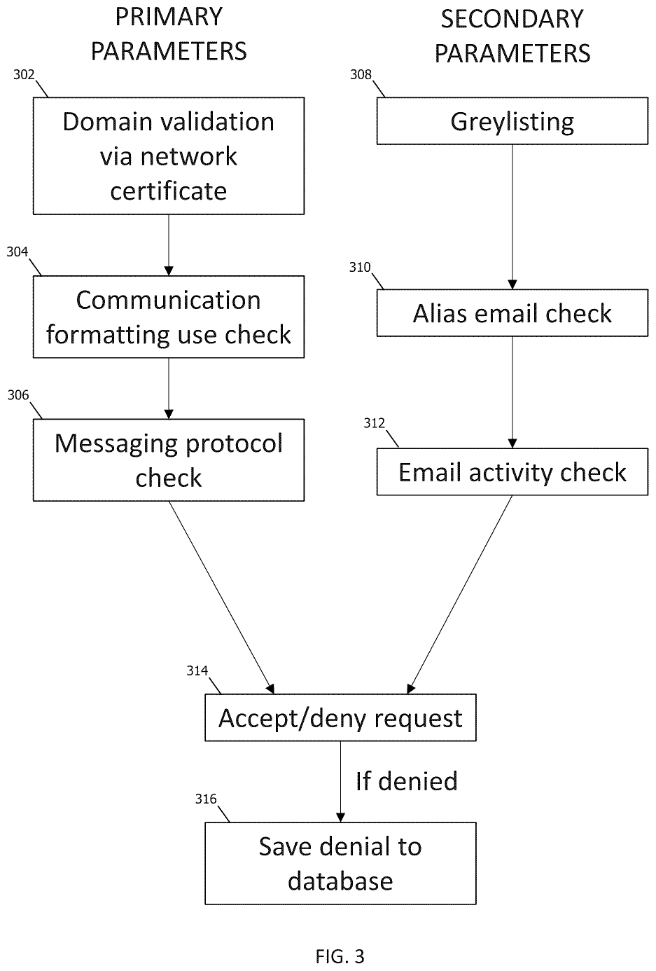

FIGS. 3-5 depict block flow diagrams associated with exemplary computer-implemented method(s) for ensuring authentic user-merchant association and services. Some steps may be performed concurrently as opposed to sequentially and may in some cases be performed in a different order. In addition, some steps may be optional. The computer-implemented method(s) are described below, for ease of reference, as being executed by exemplary devices and components introduced with the embodiments illustrated in FIGS. 1 and 2. For example, the steps of the computer-implemented method(s) may be performed by the fraud managers 10, services servers 16, and databases 18 described above, at least in part through the utilization of processors, transceivers, hardware, software, firmware, or combinations thereof. In one or more embodiments, the steps set out below for a single fraud manager 10, services server 16, and database 18 are repeated in connection with the operation of a plurality of fraud managers 10, services servers 16, and databases 18 within the same general vicinity, at the same premises, or connected to a shared network. A person having ordinary skill will also appreciate that responsibility for all or some of such actions may be distributed differently among such devices or other computing devices without departing from the spirit of the present invention.

One or more computer-readable medium(s) may also be provided. The computer-readable medium(s) may include one or more executable programs, such as a controller program, stored thereon, wherein the program(s) instruct one or more processing elements to perform all or certain steps outlined herein. The program(s) stored on the computer-readable medium(s) may instruct the processing element(s) to perform additional, fewer, or alternative actions, including those discussed elsewhere herein.

Referring to FIG. 3, an email check service program may be executed to ensure authentic user-merchant association between a user and a subscription service. The email check service program may be stored and executed on a fraud manager computing device and may ensure an authentic user merchant association exists prior to the consumption of services provided by a subscription service. Likewise, the email check service program may detect fraudulent (non- authentic) user merchant association in order to deny a request for access to a subscription service, and/or may forward the request to a merchant (alone or in combination with a recommendation) such that the merchant may determine whether to accept or deny the request.

Steps 302-312 may be executed by or in connection with the email check service program. Step 302-306 may relate to primary parameters, and steps 308-312 may relate to secondary parameters. Referring more specifically to step 302, the email check service program conducts a domain validation via a network certificate. The email check service program may retrieve a network certificate from or in connection with a request for services and verify, either internally or via a third party, whether the network certificate is a valid network certificate and/or whether the network certificate has expired. The certificate may be an SSL/TSL certificate used in connection with an existing DNS. The DNS (domain name system) is the decentralized method to identify computers, services, and other resources reachable via the World Wide Web. The result(s) of step 302 may be taken into account by the email check service program. In one or more embodiments, the results of step 302 may be scored and weighted relative to other parameters of method 300 discussed in more detail below, e.g., at a weight of 20% relative to the other parameters. For example, a valid and unexpired network certificate from the request may be less indicative of fraud. In another example, an invalid or expired network certificate from the request may be more indicative of fraud.

Referring to step 304, the email check service program may conduct a communication formatting use check across multiple merchants and regions. Step 304 may include analyzing email headers and return paths of emails from an IP address associated with the request for services to determine whether the request deviated—for example, with respect to an expected pattern or one or more data elements—from prior requests created by the same IP address. The result(s) of step 304 may be taken into consideration by the email check service program. In one or more embodiments, the results of step 304 may be scored and weighted relative to other parameters of method 300 discussed in more detail elsewhere herein, e.g., at a weight of 20% relative to the other parameters. For example, consistently formatted headers and consistent return paths originating from the same IP address associated with a plurality of requests may be more indicative of fraud, with the indication of fraud increasing with the number of requests with such headers and return paths.

Referring to step 306, the email check service program may conduct a messaging protocol check. The messaging protocol check may include determining whether a server associated with the request is connected to the World Wide Web, determining whether a firewall is blocking communication from the associated server, determining whether the server associated with the request is allowing for the relaying of the particular domain used in requesting the service subscription, determining whether the server associated with the request is responding with an adequate hostname, and determining whether a connection to the server associated with the request works outside of the connection established with the email check service program. The result(s) of step 306 may be taken into consideration by the email check program. In one or more embodiments, the results of step 306 may be scored and weighted relative to other parameters of method 300 discussed in more detail elsewhere herein, e.g., at a weight of 20% relative to the other parameters. For example, a request passing the messaging protocol check may be less indicative of fraud. In another example, a request failing the messaging protocol check may be more indicative of fraud. As a request fails more of the aforementioned criteria listed in the messaging protocol check, the indication of fraud may also increase.

Referring to step 308, the email check service program may conduct host and domain greylisting. In connection with greylisting, the email check service program may temporarily reject an email from a sender that the email check service program does not recognize. If the email is legitimate, a server from which the email originated may attempt to send the email again after a sufficient delay.

In one or more embodiments, the actions in connection with greylisting may be conducted by a software application for describing, executing, and enabling the greylisting program sequences and communications, such as those used and transmitted, and made available under SPAMHAUS® (a registered trademark of the Spamhaus Project SLU), SPAMCO® (a registered trademark of Cisco Systems, Inc.), and URIBL® (a registered trademark of uribl.com) as of the date of initial filing of the present disclosure. One of ordinary skill will appreciate that the greylisting communication may be achieved according to other greylisting standards and technologies without departing from the spirit of the present invention. In one or more embodiments, the processing element 200 and communication element 202 may use signals corresponding to one or more greylisting standard(s) to process, route, connect, establish, or disconnect to and/or from other third-party devices when greylisting emails and requests.

The results of step 308 may be taken into consideration by the email check program. In one or more embodiments, the results of step 308 may be scored and weighted relative to other parameters of method 300 discussed in more detail elsewhere herein, e.g., at a weight of 20% relative to the other parameters. For example, a subsequent request may be more indicative of fraud if the subsequent request matches the format of a temporarily rejected request.

Referring to step 310, the email check service program may conduct an alias email check to determine whether an email address from which a request for access to the subscription service originated is registered as an alias email address for one or more other email addresses that have either exhausted the trial period of the subscription service, have been denied access to the subscription service, and/or have been blacklisted from the subscription service. The result of step 310 may be taken into consideration by the email check program. In one or more embodiments, the results of step 310 may be scored and weighted relative to other parameters of method 300 discussed in more detail elsewhere herein, e.g., at a weight of 10% relative to the other parameters. For example, a request is more indicative of fraud if the request is registered as an alias email address for the one or more email addresses that have either exhausted the trail period of the subscription service, have been denied access to the subscription service, and/or have been blacklisted from the subscription service.

Referring to step 312, the email check service program may conduct an email activity check. The email activity check may include determining the number of emails received in a pre-determined span of time immediately prior to receiving an email from the email address requesting access to the subscription service. The result of step 312 may be taken into consideration by the email check program. In one or more embodiments, the results of step 312 may be scored and weighted relative to other parameters of method 300 discussed in more detail elsewhere herein, e.g., at a weight of 10% relative to the other parameters. For example, a request may be more indicative of fraud if a higher volume of requests were received in the pre-determined span of time.

Referring to step 314, the email check service program may generate a weighted final score based at least in part on the results of steps 302-312. The weighted final score may be used to accept or deny the subscription service request, depending on, for example, a threshold of the corresponding merchant or service provider for accepting or denying requests. Also, or alternatively, the weighted final score may help the merchant or service decide whether the corresponding user is allowed to be associated with the subscription service in the future.

Referring to step 316, the email check service program may store any combination of scores or denials to a database, along with identifying features of the request (e.g., the email address, the user, and other identifying information). The database may store any score and denial among other scores and denials in the database such that the database may enable searches for all previous scores and denials during a future subscription service request from an unknown email address or otherwise utilize the data to inform similar determinations.

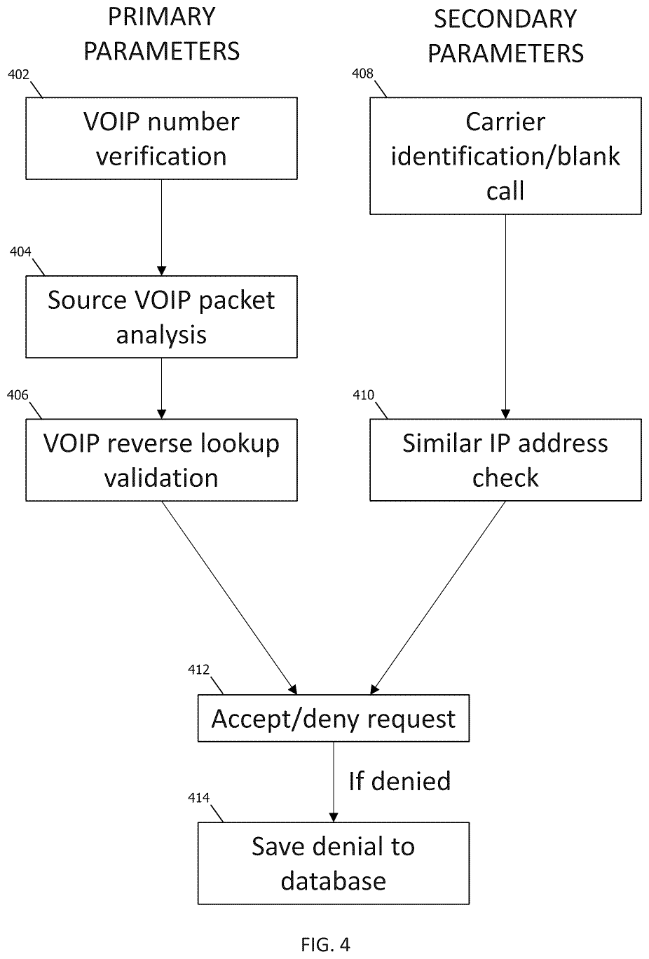

Referring to FIG. 4, a mobile check service program may be executed to ensure authentic user-merchant association between a user and a subscription service. The mobile check service program may be stored and executed on a fraud manager computing device and may ensure an authentic user merchant association exists prior to the consumption of services provided by a subscription service. Likewise, the mobile check service program may detect fraudulent (non-authentic) user merchant association in order to deny a request for subscription service use, and/or may forward the request to a merchant (alone or in combination with a recommendation and/or the results of steps 302-312 discussed above), such that the merchant may determine whether to accept or deny the request.

Steps 402-410 may be used in connection with the mobile check service program. Step 402-406 may relate to primary parameters, and steps 408-410 may relate to secondary parameters. Referring to step 402, the mobile check service program may conduct a voice over internet protocol (VOIP) telephone address verification. As part of the VOIP telephone address verification, the mobile check service program may identify telephone addresses commonly associated with a plurality of carriers to determine whether the telephone address requesting a subscription service is similar to the telephone addresses commonly associated with the plurality of carriers.

In one or more embodiments, the mobile check service program may run an API in connection with step 402. The API may include authentication measures and callouts used and transmitted in accordance with standards put forth by Vonage Holdings Corporation under the marks Vonage Communications APITM and VERIFY APITM. One of ordinary skill will appreciate that the mobile number verification conducted by the API may be achieved according to other standards and technologies without departing from the spirit of the present invention. In one or more embodiments, the processing element 200 and communication element 202 may use signals corresponding to one or more mobile number verification standard(s) to process, route, connect, establish, or disconnect to and/or from other third-party devices when verifying mobile numbers. The result(s) of step 402 may be taken into consideration by the mobile check service program. In one or more embodiments, the results of step 402 may be weighted relative to other parameters of method 400 discussed in more detail elsewhere below, e.g., at a weight of 25% relative to the other parameters. For example, a telephone address found to be associated with a carrier may be less indicative of fraud. In another example, a telephone address found not to be associated with a carrier may be more indicative of fraud.

Referring to step 404, the mobile check service program may analyze packets associated with the VOIP telephone address for source IP address and validation of the IP address of the VOIP number for fraud association. The result of step 404 may be taken into consideration by the mobile check service program. In one or more embodiments, the results of step 404 may be weighted relative to other parameters of method 400 discussed in more detail elsewhere herein, e.g., at a weight of 20% relative to the other parameters. For example, packets from a request originating from a flagged IP address may be more indicative of fraud.

Referring to step 406, the mobile check service program may verify a caller ID associated with the telephone address requesting a subscription service. To verify the caller ID, the mobile check service program may send to the carrier network associated with the telephone address requesting a subscription service a ping in order to retrieve a calling name value. The calling name value may be named information tied to a telephone address and may display on devices that receive a call from the telephone address. Additionally, the calling name value may indicate a geographical location of the telephone address, and the carrier network associated with the telephone address. The sequences in connection with step 406 may include authentication measures and callouts used and transmitted in accordance with standards put forth by IPQualityScore LLC or Searchbug. One of ordinary skill will appreciate that the mobile number verification conducted by the API may be achieved according to other standards and technologies without departing from the spirit of the present invention. In one or more embodiments, the processing element 200 and communication element 202 may use signals corresponding to one or more telephone address verification standard(s) to process, route, connect, establish, or disconnect to and/or from other third-party devices when verifying telephone addresses. The result(s) of step 406 may be taken into consideration by the mobile check service program. In one or more embodiments, the results of step 406 may be weighted relative to other parameters of method 400 discussed in more detail elsewhere herein, e.g., at a weight of 25% relative to the other parameters. For example, a request with a calling name value outside of a geographical region approved for subscription services may be more indicative of fraud. In another example, a request with a calling name value including the name of a previously identified fraudulent user may be more indicative of fraud. In another example, a calling name value with a telephone address of a previously identified fraudulent user may be more indicative of fraud.

Referring to step 408, the mobile check service program may identify the carrier associated with the telephone address requesting a subscription service. To identify the carrier, the mobile check service program may call the telephone address for a predetermined duration of time. In one or more embodiments, audio from the mobile check service program to the telephone address may be muted. The mobile check service program may listen for and/or record, during the predetermined duration of time, audible feedback from the call. The result of step 408 may be taken into consideration by the mobile check service program. In one or more embodiments, the results of step 408 may be weighted relative to other parameters of method 400 discussed in more detail elsewhere herein, e.g., at a weight of 15% relative to the other parameters. For example, no feedback from the call may be more indicative of fraud. In another example, feedback from the call may be more indicative of fraud if the feedback does not include a standardized dial tone. In another example, feedback from the call may be more indicative of fraud if the feedback includes a message indicating that a verified user is not associated with the telephone address from which the request originates.

Referring to step 410, the mobile check service program may search for similar telephone addresses with slight variations from those either stored in the database or previously submitted to the subscription service in question. The result of step 410 may be taken into consideration by the mobile check service program. In one or more embodiments, the results of step 410 may be weighted relative to other parameters of method 400 discussed in more detail elsewhere herein, e.g., at a weight of 15% relative to the other parameters. For example, a telephone address is more indicative of fraud if the telephone address from which the request originates contains single-digit variations from those either stored in the database or previously submitted to the subscription service, with the indication of fraud decreasing with more variations of single digits.

Referring to step 412, the mobile check service program may generate a weighted final score based at least in part on the results of step 402-410. The weighted final score may be used to accept or deny the subscription service request depending on, for example, a threshold of the corresponding merchant or service provider for accepting or denying requests. Also, or alternatively, the weighted final score may help the merchant or service decide whether the corresponding user is allowed to be associated with the subscription service in the future.

Referring to step 414, the mobile check service program may store a denial to a database, along with identifying features of the request (e.g., the email address, the user, and other identifying information). The database may store the denial among other denials in the database such that the database may search for all previous denials during a future subscription service request from an unknown email address, or otherwise utilize the data to inform similar determinations.

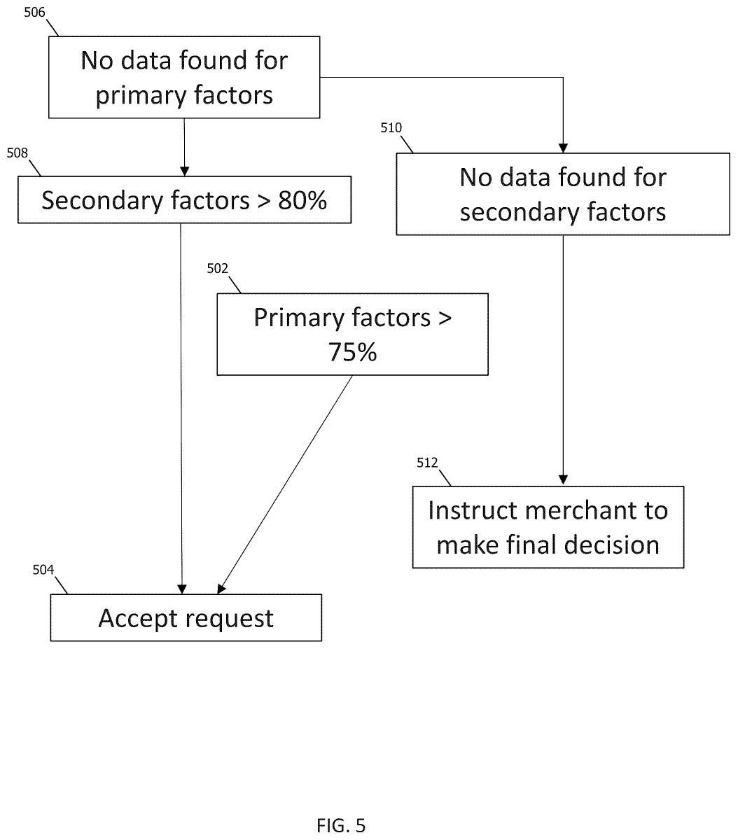

Turning now to FIG. 5, an AI model may be used, executed and/or implemented by the fraud manager 10 noted above to generate a score, wherein the score may indicate whether a subscription service request should be accepted or denied. The score may include an aggregation of primary and secondary factors between an email check service program and/or a mobile check service program.

Referring to step 502, the AI model may inquire into whether the percentages of the primary factors are greater than 75%. If the percentages of the primary factors added together are greater than 75%, the AI model may immediately accept the subscription request in step 504 without further action.

Referring to step 506, the AI model may determine that the fraud manager computing device could not locate data for the primary factors, i.e., that all primary factor scores for the email check service program and/or the mobile check service program are unavailable. If the AI model finds that no data was found for the primary factors, the AI model may accept the request in step 504 if the secondary factors are greater than 80%, as determined pursuant to step 508. Alternatively, the AI model may, after step 506, determine that the fraud manager computing device could not locate data for the secondary factors in step 510. In that case, the AI model may instruct the merchant to make the final decision regarding the acceptance or denial of the subscription in step 512 (e.g., without the benefit of a recommendation or result from the AI model).

The preferred forms of the invention described above are to be used as illustrations only and should not be utilized in a limiting sense in interpreting the scope of the present invention. Obvious modifications to the exemplary embodiments, as hereinabove set forth, could be readily made by those skilled in the art without departing from the spirit of the present invention.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element- implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by the inventor(s) includes the following:

We claim:

1. A system for identifying genuine user-merchant association, the system comprising one or more processors and/or transceivers individually or collectively programmed to:
check the validity or expiration of a network certificate associated with a request to create a certificate score, the request being from a user and for access to a trial subscription service of a merchant;
analyze previous communication from the user from which the request originates across a plurality of entities and regions to create a previous communication score, the analysis including a determination that multiple previous communications from the user embody a consistent header formatting and a common internet protocol (IP) address, the previous communication score reflecting higher fraud likelihood for consistent header formatting of the multiple previous communications from the common IP address, the consistency being indicative of attempted repeated fraudulent utilization of the trial subscription service;
conduct a messaging protocol check for a server associated with the request to create a protocol score, the messaging protocol check including and the protocol score being based on one or more of the following factors—firewall of the server associated with the request, relay of a domain associated with the request by the server associated with the request, response with a hostname by the server associated with the request, or connection with the server associated with the request that is outside an established connection;
determine whether an identity from which the request originates is not associated with a plurality of previously rejected requests to create a previous rejection score;
output a weighted final score comprising a determination of whether to accept or deny the request based at least in part on the previous rejection score and on one or more of the certificate score, the previous communication score, and the protocol score, the weighted final score incorporating a weighting toward denying the request based on the determination of the consistent header formatting and the common IP address; and
based on the determination of whether to accept or deny the request, generate a corresponding recommendation to the merchant to accept or deny the request from the user.

2. The system of claim 1, the one or more processors and/or transceivers being further individually or collectively programmed to temporarily reject an unrecognized request to create an unrecognized request score.

3. The system of claim 2, the one or more processors and/or transceivers being further individually or collectively programmed to, after temporarily rejecting the unrecognized request, allow for the reception of the unrecognized request after a sufficient delay.

4. The system of claim 1, the one or more processors and/or transceivers being further individually or collectively programmed to determine, within a preset period of time, activity performed on the account from which the request originates to create an activity score, wherein the weighted final score is further based at least in part on the activity score.

5. The system of claim 1, wherein the system—
accepts the request if the weighted final score of the request is within a threshold of weighted final scores the merchant has configured to accept the request, or
denies the request if the weighted final score of the request is outside a threshold of weighted final scores the merchant has configured to accept the request.

6. The system of claim 1, the one or more processors and/or transceivers being further individually or collectively programmed to pass the decision to accept or deny the request to the merchant.

7. The system of claim 1, wherein the weighted final score is saved in a manner suited for retrieval and use in analyzing a plurality of future requests.

8. A computer-implemented method for identifying genuine user-merchant association, the method comprising:
checking the validity or expiration of a network certificate associated with a request to create a certificate score, the request being from a user and for access to a trial subscription service of a merchant;
analyzing previous communication from the user from which the request originates across a plurality of entities and regions to create a previous communication score, the analysis including a determination that multiple previous communications from the user embody a consistent header formatting and a common internet protocol (IP) address, the previous communication score reflecting higher fraud likelihood for consistent header formatting of the multiple previous communications from the common IP address, the consistency being indicative of attempted repeated fraudulent utilization of the trial subscription service;
conducting a messaging protocol check for a server associated with the request to create a protocol score, the messaging protocol check including and the protocol score being based on one or more of the following factors—firewall of the server associated with the request, relay of a domain associated with the request by the server associated with the request, response with a hostname by the server associated with the request, or connection with the server associated with the request that is outside an established connection;
determining whether an identity from which the request originates is not associated with a plurality of previously rejected requests to create a previous rejection score;
outputting a weighted final score comprising a determination of whether to accept or deny the request based at least in part on the previous rejection score and on one or more of the certificate score, the previous communication score, and the protocol score, the weighted final score incorporating a weighting toward denying the request based on the determination of the consistent header formatting and the common IP address; and
based on the determination of whether to accept or deny the request, generate a corresponding recommendation to the merchant to accept or deny the request from the user.

9. The computer-implemented method of claim 8, the method further comprising temporarily rejecting an unrecognized request to create an unrecognized request score.

10. The computer-implemented method of claim 9, wherein, after temporarily rejecting the unrecognized request, the method allows for the reception of the unrecognized request after a sufficient delay.

11. The computer-implemented method of claim 8, the method further comprising determining, within a preset period of time, activity performed on the account from which the request originates to create an activity score, wherein the weighted final score is further based at least in part on the activity score.

12. The computer-implemented method of claim 8, the method further comprising accessing the weighted final score for a plurality of future requests, such that the method can more easily identify genuine user-merchant association.

13. The computer-implemented method of claim 8, the method further comprising passing the decision to accept or deny the request to the merchant.

14. Non-transitory computer-readable storage media having computer- executable instructions stored thereon for identifying genuine user-merchant association, wherein when executed by at least one processor the computer-executable instructions cause the at least one processor to:
check the validity or expiration of a network certificate associated with a request to create a certificate score, the request being from a user and for access to a trial subscription service of a merchant;
analyze previous communication from the user from which the request originates across a plurality of entities and regions to create a previous communication score, the analysis including a determination that multiple previous communications from the user embody a consistent header formatting and a common internet protocol (IP) address, the previous communication score reflecting higher fraud likelihood for consistent header formatting of the multiple previous communications from the common IP address, the consistency being indicative of attempted repeated fraudulent utilization of the trial subscription service;
conduct a messaging protocol check for a server associated with the request to create a protocol score, the messaging protocol check including and the protocol score being based on one or more of the following factors-firewall of the server associated with the request, relay of a domain associated with the request by the server associated with the request, response with a hostname by the server associated with the request, or connection with the server associated with the request that is outside an established connection;
determine whether an identity from which the request originates is not associated with a plurality of previously rejected requests to create a previous rejection score;
output a weighted final score comprising a determination of whether to accept or deny the request based at least in part on the previous rejection score and on one or more of the certificate score, the previous communication score, and the protocol score, the weighted final score incorporating a weighting toward denying the request based on the determination of the consistent header formatting and the common IP address; and
based on the determination of whether to accept or deny the request, generate a corresponding recommendation to the merchant to accept or deny the request from the user.

15. The storage media of claim 14, wherein the computer-executable instructions cause the at least one processor to temporarily reject an unrecognized request to create an unrecognized request score.

16. The storage media of claim 15, wherein the computer-executable instructions cause the at least one processor to, after temporarily rejecting the unrecognized request, allow for the reception of the unrecognized request after a sufficient delay.

17. The storage media of claim 14, wherein the computer-executable instructions cause the at least one processor to determine, within a preset period of time, activity performed on the account from which the request originates to create an activity score, wherein the weighted final score is further based at least in part on the activity score.

18. The storage media of claim 14, wherein the computer-executable instructions cause the at least one processor to—
accept the request if the weighted final score of the request is within a threshold of weighted final scores the merchant has configured to accept the request, or
deny the request if the weighted final score of the request is outside a threshold of weighted final scores the merchant has configured to accept the request.

19. The storage media of claim 14, wherein the computer-executable instructions cause the at least one processor to pass the decision to accept or deny the request to the merchant.

20. The storage media of claim 14, wherein the weighted final score is saved in a manner suited for retrieval and use in analyzing a plurality of future requests.
